(19) United States
(12) Patent Application Publication
(10) Pub. No.: US 2002/0093116 A1
(43) Pub. Date: Jul. 18, 2002

(54) PVA foam recycling process

(76) Inventor: Ming-Ti Hsieh, Taipei City (TW)

Correspondence Address: MING-TI HSIEH, P.O. BOX 7-820, TAIPEI, TW

(21) Appl. No.: 09/761,621

(22) Filed: Jan. 18, 2001

(51) Int. Cl. B29B 17/00

(52) U.S. Cl. 264/115; 264/916

(57) ABSTRACT

A waste PVA foam recycling process to crashes the waste PVA foam into evenly distributed grains, then grains are placed into a molding die while a PVA mixing agent is added into grains. Both of the agent and grains are polymerized, heat dehydrated and hardened into an integral compound to create friction resistance between soft and hard components for removing pollutants. The PVA foam grains can be further admixed with color grains to create merchandisable patterns. Therefore, the present invention, by reclaiming the waste PVA foam and to producing zero pollutant recycled PVA foam with economic value.

### BACKGROUND OF THE INVENTION

(a) Field of the Invention

The present invention relates to a recycling process of PTA foam, and more particularly to one that reclaims waste PVA foam to produce environmental compliance recycled PVA foam free of pollutants and that can be reclaimed for reuse.

(b) Description of the Prior Art

In the prior art of PVA water absorbent foam involves a manufacturing process of a chemical reaction among PVA, pigment, foaming agent, catalyst and formaldehyde. The mixture is then put through the process flow of injection molding □ hot dehydration □ rinse □ cutting □ rinse □ packaging. PVA foam has been massively and widely used in daily consumption items, such as those for hygienic and bathing purposes, a mop, and even for electronic and medical industries. However, the waste PVA foam resulted from the process is converted to thermoset plastic that prevents reprocess. Therefore the waste PVA foam is usually incinerated causing damage and pollution to various types of ecological balance. Furthermore, disposal of PU foam and EVA foam can not be applied the same for the waste PVA foam since the properties of PVA is different from that of PU or EVA.

### SUMMARY OF THE INVENTION

The primary purpose of the present invention is to provide a process for recycling waste PVA foam so that the recycled PVA foam is free of pollution to the environment by introducing a chemical reaction between the waste PVA foam crashed into grains and PVA mixing agent. The resultant mixture is then injected into a molding-die for polymerization to become an integral compound spaced with hard and soft portions in between after heat dehydration.

The secondary purpose of the present invention is to provide a process for recycling waste PVA foam so that the hard and soft portions spaced in between of the compound when hardened to significantly increase the local friction resistance coefficient for removing pollutants.

Another purpose yet of the present invention is to provide a process for recycling waste PVA foam so that color PVA foam grains can be added into the process to combine various patterns for finished product to improve its appearance and commercial value.

### BRIEF DESCRIPTION OF THE DRAWINGS

FIG. 1 shows a preferred embodiment of the present invention.

FIG. 2 is a view of the composition of the present invention.

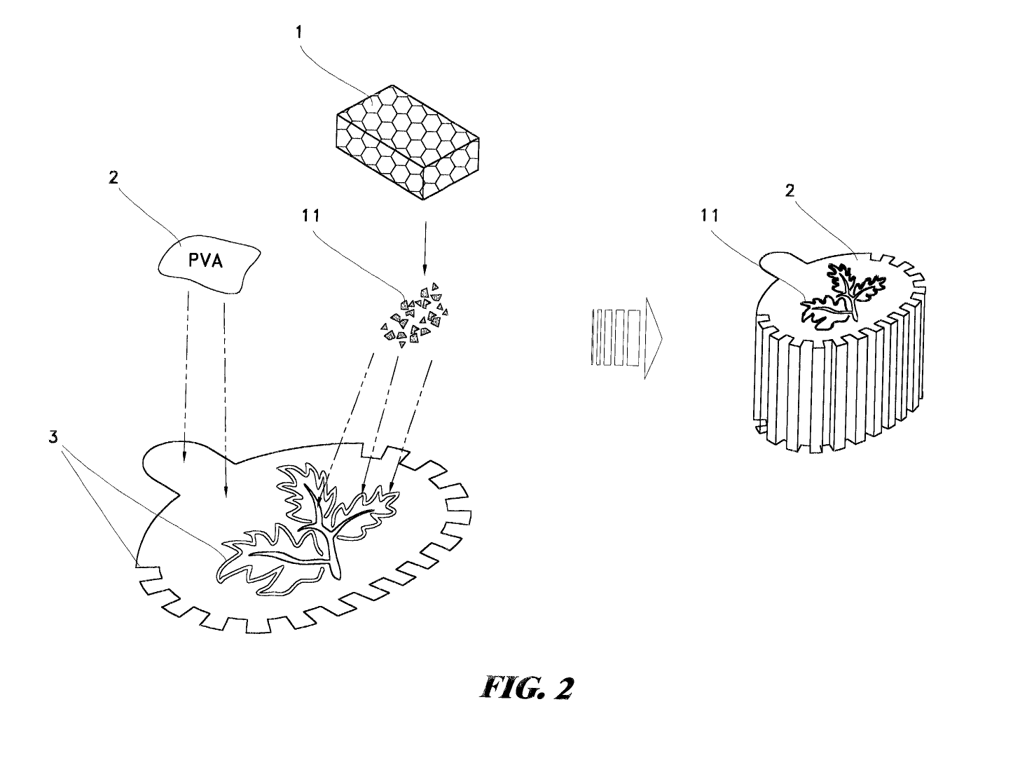

FIG. 3 is a view showing pollutants are removed by local friction resistance created by those hard and soft portions spaced in between in the present invention.

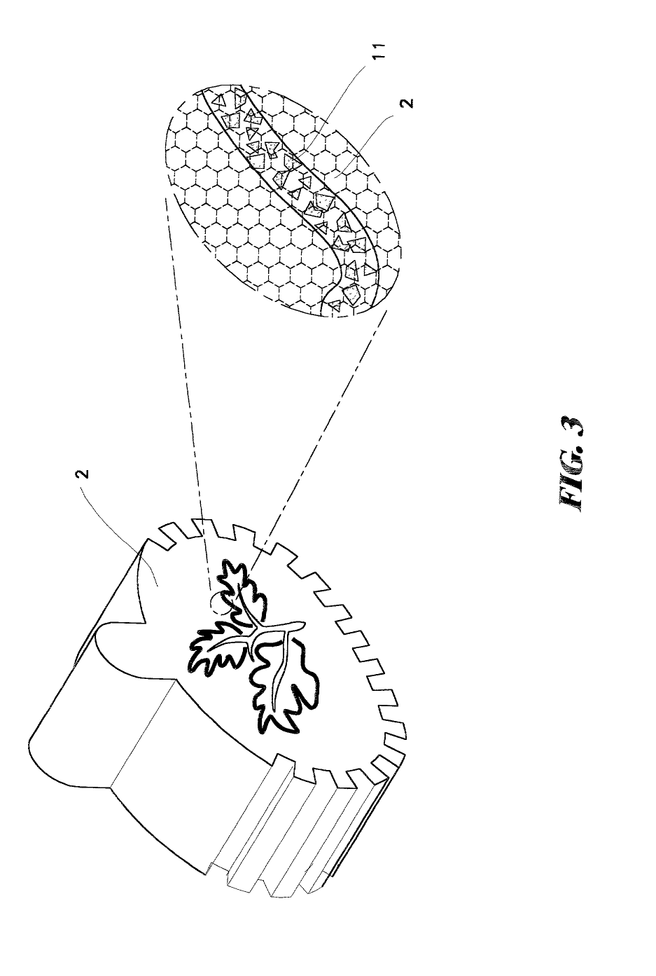

FIG. 4 is a flow chart of the present invention.

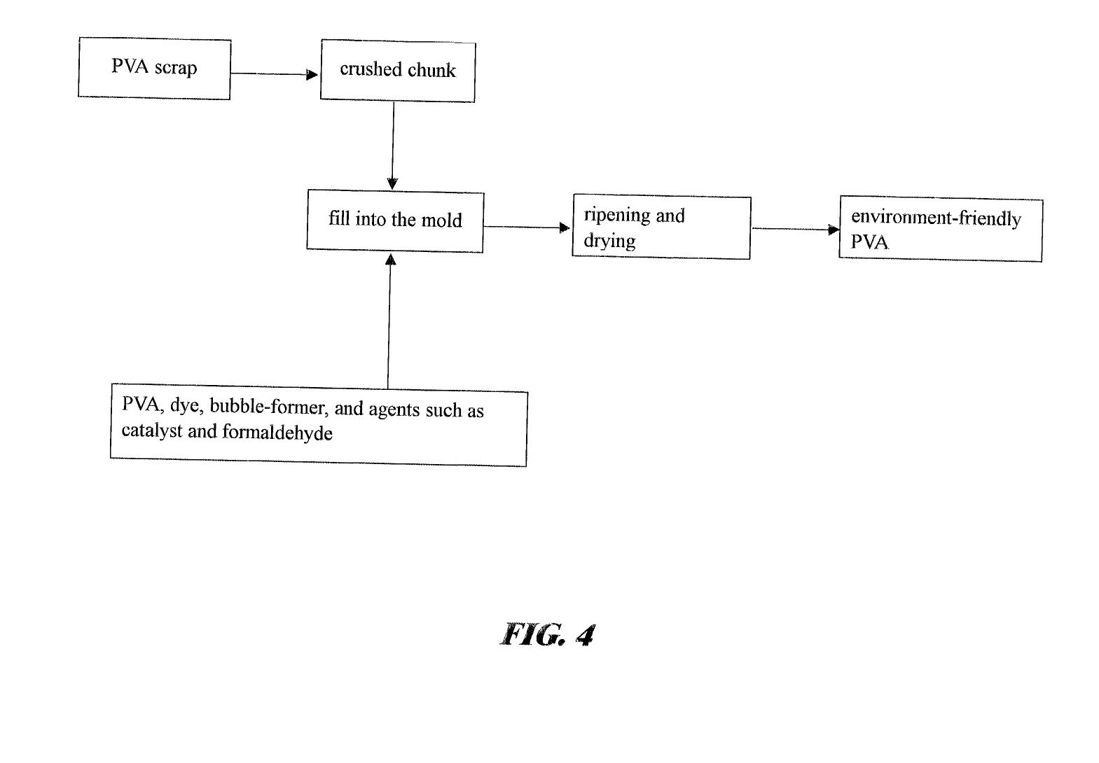

### DETAILED DESCRIPTION OF THE PREFERRED EMBODIMENT

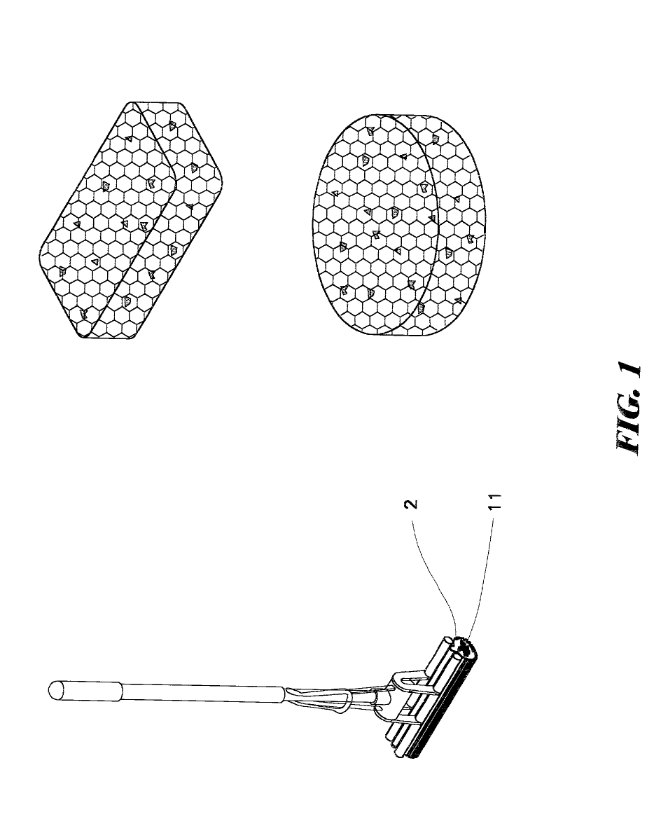

As illustrated in FIGS. 1˜4, the present invention relates to a waste PVA foam recycling process. Within, waste PVA foam 1 is evenly crashed into grains 11. The grains 11 and a mixing agent 2 comprised of PVA, pigment, foaming agent, catalyst and formaldehyde are respectively injected into a molding-die 3 for polymerization into an integral compound after hot dehydration and hardening. The newly polymerized portion of the compound is softer than that formed by the waste PVA foam, resulting in soft and hard portions spaced in between to create multi-fold local friction resistance coefficient for removing pollutants.

Furthermore, by utilizing the combination of color waste PVA foams, merchandisable products with diversified patterns can be derived from any preferred embodiment of the present invention to achieve a breakthrough for traditional PVA foam products that feature only single color. Finished products processed by the present invention permit to be reclaimed and recycled to guarantee zero pollution, environmental compliance and economical value.

I claim:

1. A waste PVA foam recycling process, within, the waste PVA foam is evenly crashed into grains; both of the grains and a PVA mixing agent are respectively injected into a molding-die to be polymerized, hot dehydrated, and hardened to foam an integral compound that is free of pollutants and can be reclaimed and recycled for economic use.

2. A waste PVA foam recycling process as claimed in claim 1, wherein, the newly polymerized of the recycled PVA foam of the compound is softer than that of the waste PVA foam, thus to form a unique structure of the soft and the hard parts are spaced in between to create multiple folded friction resistance coefficient for removing pollutants.

3. A waste PVA foam recycling process as claimed in claim 1, wherein, finished products in colorful and diversified variations of patterns for the recycled PVA foam can be derived by adding into color waste PVA foam or grains.
